(19) United States
(12) Patent Application Publication
(10) Pub. No.: US 2025/0196135 A1
(43) Pub. Date: Jun. 19, 2025

(54) Microfluidic Device and Method for Operating a Microfluidic Device

(71) Applicant: Robert Bosch GmbH, Stuttgart (DE)

(72) Inventor: Daniel Sebastian Podbiel, Rutesheim (DE)

(21) Appl. No.: 18/847,753

(22) PCT Filed: Mar. 23, 2023
(86) PCT No.: PCT/EP2023/057417

§ 371 Date: Sep. 17, 2024

(30) Foreign Application Priority Data
Mar. 24, 2022 (DE) 10 2022 202 864.3

(51) Int. Cl. B01L 3/00

(52) U.S. Cl. CPC B01L 3/50273; B01L 3/502715; B01L 2200/025; B01L 2200/04; B01L 2200/16; B01L 2300/168; B01L 2400/0457; B01L 2400/049; B01L 2400/0622

(57) ABSTRACT

A microfluidic device comprises a pneumatic interface for connecting the device to an analysis device and a fluidic channel system with a plurality of fluidic microchannels for transporting a fluid. The fluidic channel system comprises a plurality of microfluidic elements connected via the fluidic microchannels. The fluidic microchannels have first fluidics sections aligned along a first direction and second fluidics sections aligned along a second direction. The device comprises a pneumatic channel system with a plurality of pneumatic microchannels for controlling the microfluidic elements, wherein the pneumatic microchannels have first pneumatics sections aligned along the first direction and second pneumatics sections aligned along the second direction. An entire length of the first fluidics sections is greater than an entire length of the second fluidics sections and an entire length of the first pneumatics sections is smaller than an entire length of the second pneumatics sections.

### PRIOR ART

The invention is based on a microfluidic device and a method for operating a microfluidic device according to the generic type of the independent claims.

Microfluidic analysis systems (so-called lab-on-chips, LoC for short) enable automated, reliable, fast, compact and cost-effective processing of patient samples for medical diagnostics. By combining a variety of operations for the controlled manipulation of fluids, complex molecular diagnostic test sequences can be performed in a microfluidic device, which is also referred to as a lab-on-chip cartridge. Processing of the lab-on-chip cartridge and analysis of the patient sample can be done in a compact analysis device. Various types of microfluidic analysis systems are known from prior art, which are also referred to as lab-on-chip platforms or lab-on-chip systems. Such lab-on-chip platforms take various technological approaches for providing the microfluidic operations: For example, centrifugal-based lab-on-chip systems make use of the centrifugal, Coriolis, and Euler forces that occur in a lab-on-chip cartridge placed in controlled rotation. Another class of lab-on-chip platforms are the pressure-based systems, which, by applying at least two pressure levels to a microfluidic cartridge, achieve controlled liquid transport in the cartridge.

### DISCLOSURE OF THE INVENTION

In this context, the approach presented here provides an improved microfluidic device and an improved method for operating a microfluidic device according to the independent claims. Measures listed in the dependent claims allow for further advantageous embodiments and improvements to the device stated in the independent claim.

The microfluidic device presented here advantageously allows for a particularly high integration density, that is, a particularly compact arrangement of the active microfluidic elements.

A microfluidic device for processing a fluid is presented. The device comprises a pneumatic interface for connecting the device to an analysis device, wherein the analysis device is configured to apply at least two different pressure levels to the interface. In addition, the device comprises a fluidic channel system having a plurality of fluidic microchannels for transporting the fluid. The fluidic channel system comprises a plurality of microfluidic elements connected by the fluidic microchannels configured to cause controlled displacement of the fluid by pneumatic actuation. The fluidic microchannels have first fluidics sections aligned along a first direction and second fluidics sections aligned along a second direction, with a fluidics section being particularly understood as a section of a fluidic microchannel. The microfluidic device also comprises a pneumatic channel system having a plurality of pneumatic microchannels for controlling the microfluidic elements. The pneumatic channel system is connected to the pneumatic interface, wherein the pneumatic microchannels comprise first pneumatic sections aligned along the first direction and second pneumatic sections aligned along the second direction, with a pneumatic section being particularly understood as a section of a pneumatic microchannel. An entire length of the first fluidics sections is greater than an entire length of the second fluidics sections and an entire length of the first pneumatics sections is smaller than an entire length of the second pneumatics sections.

The fluidic channel system and the pneumatic channel system may, for example, be configured as part of a microfluidic network. This may comprise the fluidic microchannels as well as the active, pneumatically controllable microfluidic elements. For example, the microfluidic elements may be pneumatically actuable membrane-based fluid displacement chambers for controlled transport of liquids, particularly a sample liquid, in the fluidic microchannel network of the microfluidic device. The active microfluidic elements may be controlled via the pneumatic microchannels, which in turn form a connection of the pneumatic interface to a processing unit, which allows at least two pressure levels to be applied to the microfluidic device. The device or lab-on-chip platform presented here is, therefore, the pressure-based system, which, by applying at least two pressure levels to a microfluidic cartridge, may achieve controlled liquid transport in the cartridge. To this end, the microfluidic cartridge comprises in particular a plurality of pneumatic microchannels for the defined guiding of a gaseous medium exposed to overpressure or negative pressure, for example, air, within the microfluidic cartridge, as well as a microfluidic network of fluidic microchannels for guiding liquids within the microfluidic cartridge. In other words, active microfluidic elements, in particular membrane-based valves and pump chambers, are used to control and produce fluid transport within such a microfluidic lab-on-chip cartridge. For example, by deflecting a flexible membrane onto a valve saddle or into a pump chamber, microfluidic flow through a channel can be controlled or a microfluidic transport of liquids can be produced. Control of the active microfluidic elements is, in particular, carried out by a processing unit or the analysis device, and via pneumatic microchannels, which are integrated into the microfluidic device. The pneumatic interface may be suitably configured to enable control by the analysis device on one hand, and on the other hand, suitably implemented into the microfluidic device to permit control of all active microfluidic elements in the microfluidic device. The microfluidic device is characterized in that an entire length of the first fluidics sections is greater than an entire length of the second fluidics sections and an entire length of the first pneumatics sections is smaller than an entire length of the second pneumatics sections. For example, the first fluidics sections as well as the first pneumatics sections may be primarily vertically aligned in the operational state of the device and the second fluidics sections as well as the second pneumatics sections may be horizontally aligned. For example, the entire length of the second pneumatics sections may be similar to the entire length of the first fluidics sections. An entire length of all channels or all channel sections along a direction of space is understood to mean the sum of the lengths of the individual channels projected in this direction of space. Such a system architecture advantageously allows a particularly compact arrangement and guidance of fluidics and pneumatics. In this way, a particularly high integration density (comparable to the integration density of transistors on integrated circuits) of active microfluidic elements may be achieved for use in a microfluidic network. Due to the increased integration density, the device may have reduced overall dimensions as well as reduced dead volumes in the microfluidic network. Furthermore, the material costs for manufacturing the microfluidic device may be reduced. This makes particularly cost-efficient and sustainable or resource-saving manufacturing of the microfluidic device possible. In addition, by reducing the dead volumes within the microfluidic network, the amount of reagents employed may be reduced. The first direction may be different from the second direction. Both directions may be oblique or transverse with respect to each other.

According to one embodiment, the first direction may be oriented orthogonally to the second direction. Accordingly, the second pneumatics sections of the pneumatic microchannels may have a primarily perpendicular or orthogonal orientation with respect to the first fluidics sections of the fluidic microchannels. A length of all fluidic microchannels along the first direction of space may be greater than a length of all pneumatic microchannels along the first direction of space and a length of all pneumatic microchannels along a second direction of space that is perpendicular or orthogonal to the first direction of space may be greater than a length of all fluidic microchannels along the second direction of space. This allows for improved microfluidic system architecture, which is characterized by orthogonal alignment, i.e., perpendicular orientation of the fluid-conducting fluidic microchannels and the pneumatic microchannels configured to control the active microfluidic elements, to facilitate liquid transport within the device. By designing the fluidic and pneumatic channels within the microfluidic device as perpendicular to one another insofar as possible, an overlap of fluidics and pneumatics microchannels may advantageously be prevented in a particularly simple manner. This is particularly advantageous if the microfluidic device is realized as a polymeric multilayer construction, which is joined together with laser through-beam welding. Since a spatially homogeneous contact pressure of the joined elements is of high importance with this joining method, overlapping of fluidic and pneumatic channels is disadvantageous. While in the case of parallel guiding of the fluidic and pneumatic microchannels in relation to one another, an overlap of the channels can only be achieved by a spatial displacement of the channels within the lateral plane, the spatial extension of an undesired overlap over the channel width, and thus in general, can be significantly reduced by using a vertical configuration of the fluid and pneumatic microchannels.

For example, the entire length of the first fluidics sections may be at least twice as large or at least four times as large as the entire length of the second fluidics sections. Additionally, or alternatively, the entire length of the first pneumatics sections may be at most half as large or at most one quarter as large as the entire length of the second pneumatics sections. This makes a very compact design possible.

According to another embodiment, a spatial extension of a microfluidic network comprising the fluidic channel system and the pneumatic channel system along the first direction may be greater than the spatial extension along the second direction. A spatial extension of the pneumatic interface along the first direction may be greater than the spatial extension of the pneumatic interface along the second direction. The first direction and the second direction may be arranged perpendicularly or orthogonally to one another. Advantageously, a particularly compact, pneumatically actuable form of the microfluidic device can thereby be implemented.

According to another embodiment, in an operational state of the device, a force component of the earth's gravitational field may act along the first direction. For example, in the operational state of the device, the first direction of the space may be aligned with a gravitational field such that a non-vanishing force component of the gravitational field may act along the first direction of the space, or the projection of the field lines of the gravitational field in the first direction of the space may be non-vanishing. For example, a vertical dimension of the pneumatic interface may be greater than a horizontal dimension of the pneumatic interface and a transport of liquids within the microfluidic device may occur particularly along the vertical direction, wherein the vertical dimension of the fluidic network may be greater than the horizontal dimension of the fluidic network. Advantageously, fluid transport within the device and corresponding desired analysis processes can be optimized, for example, by removing gas bubbles.

According to another embodiment, the pneumatic interface may comprise an arrangement of pneumatic connections for connecting the pneumatic channel system to the analysis device. For example, a plurality of active microfluidic elements may be controlled via a common pneumatic interface having multiple pneumatic ports, which may, therefore, also be referred to as a manifold. By advantageous shaping of the pneumatic interface as a manifold comprising a plurality of pneumatic connections, pneumatic control of the microfluidic device in an external processing unit can be achieved in a particularly simple and compact manner.

In addition, the connections of the pneumatic interface may be arranged in at least two rows along the first direction, wherein the connections are hexagonal to each other and, additionally or alternatively, equidistantly arranged. For example, the pneumatic microchannels emanating from the connections of one series may be formed between the connections of the other series, and, in particular, the pneumatic microchannels emanating from those connections. In this case, the connections of the pneumatic interface may be arranged on a hexagonal grid and equidistantly, that is, with the same distance to one another. Advantageously, a particularly compact configuration of the pneumatic interface can thereby be made possible while simultaneously providing optimal controllability of the microfluidic elements.

According to another embodiment, the pneumatic interface may form a maximum of one half of a total surface area of the device. In particular, the interface may be arranged adjacent to an edge of the device. An arrangement of the pneumatic interface in an edge region of the device, in particular an arrangement between an edge of the device and the microfluidic network, in particular between the edge and the fluidic channel system, allows a particularly simple force exertion for as dense a pneumatic connection between the pneumatic interface and external pneumatic connections as possible, of the analysis device in particular, and, advantageously, avoids force exertion on the microfluidic network, particularly on the fluidic channel system. An arrangement of the pneumatic interface in an edge region of the device further has the advantage that potentially undesirable functional impairments of the pneumatic interface are reduced by processes in the fluidic network, in particular a temperature impact on the interface. For example, the pneumatic interface may be arranged within half or one third of the device, and, particularly, adjacent to the edge of the device. Advantageously, a compact configuration of the pneumatic interface can be allowed as a result. In addition, passage of fluidic microchannels through the pneumatic interface can thereby be avoided.

According to another embodiment, the device may comprise at least one liquid reagent pre-storage chamber for long-term stability of liquid pre-storage within the microfluidic device. Advantageously, the liquid reagent pre-storage chamber may be configured to pre-store a liquid required for an analysis process in a manner that allows for long-term stability and is contamination-free. Preferably, at least one liquid reagent pre-storage chamber is arranged with respect to the pneumatic interface in such a manner that the liquid reagent pre-storage chamber is located above the pneumatic interface for an intended, particularly tilted, use with respect to gravity. Intended use may be understood as an operational state of the device, preferably after mounting the device in an analysis device, in which the device is preferably tilted/inclined for operation.

According to a particularly preferred embodiment, the pneumatic interface is arranged in a first edge region of the device adjacent to the fluidic network, particularly to the fluidic and/or pneumatic channel system. Preferably, at least one liquid reagent pre-storage chamber is arranged in a second edge region of the device, wherein the second edge region is adjacent to the fluidic network, in particular to the fluidic and/or pneumatic channel system. Preferably, the second edge region is the upper edge region of the cartridge or the microfluidic network when the device is used as intended, with respect to the effective gravitational force. This has the advantage that liquid from the pre-storage chamber can be introduced into the fluidic canal system using the acting gravitational force. According to a particular embodiment, a liquid reagent pre-storage chamber extends more than 50%, preferably more than 70%, quite preferably more than 90% of the width of the device along the second direction, for example along the second direction. The first edge region and the second edge region may extend in different directions along the length of the cartridge, preferably being orthogonally aligned to each other. For example, the fluidic network, in particular the fluidic and/or pneumatic channel system, may be (substantially) arranged in a rectangular area of the device. The first edge region may extend along a first length of the rectangular area and the second edge region may extend along a second length of the rectangular area, wherein the two lengths are preferably orthogonally aligned with each other. Preferably, the pneumatic interface may extend along the first direction or be aligned in the first direction, while at least one liquid reagent pre-storage chamber extends along the second direction or is aligned in the second direction. In particular, the pneumatic interface and the at least one liquid reagent pre-storage chamber have a (substantially) rectangular base shape, wherein the longer rectangular side of the pneumatic interface extends in the first direction and the longer rectangular side of the liquid reagent pre-storage chamber extends in the second direction.

According to another embodiment, the device may comprise a first polymeric layer and a second polymeric layer, which may be joined to a flexible membrane at least in sub-areas. More fluidic microchannels may be arranged in the first polymeric layer than in the second polymeric layer and more pneumatic microchannels may be arranged in the second polymeric layer than in the first polymeric layer. For example, the device may be implemented in the form of a multilayer polymeric construction with a first polymeric component or assembly of polymeric components and a second polymeric component or assembly of polymeric components. These may each be connected to a flexible membrane at least in sub-areas, wherein a plurality of the fluidic microchannels may be implemented in the first polymer component or the first assembly of polymer components and a plurality of the pneumatic microchannels may be realized in the second polymer component or the second assembly of polymer components. Thus, the integration of a flexible membrane into the lab-on-chip cartridge may combine several advantages. A targeted deflection of the membrane into dedicated recesses having defined dimensions in the lab-on-chip cartridge can be used to process defined liquid volumes, for example by displacing or aspirating. Furthermore, by employing a flexible membrane that is integrated into a lab-on-chip cartridge, the liquids may be nearly completely enclosed in the lab-on-chip cartridge (only venting channels are required) and the membrane may separate the pneumatic areas of the lab-on-chip cartridge from the fluidic areas. This can advantageously prevent contamination of the environment by the sample or vice versa. In addition, these types of microfluidic lab-on-chip cartridges in the form of a polymeric multilayer construction may be produced cost-effectively from polymers using series production methods such as injection molding, injection stamping, punching or laser transmission welding.

In addition, the flexible membrane may have absorbent properties at a predetermined wavelength, and the first polymeric layer and, additionally or alternatively, the second polymeric layer may have transparent properties at the wavelength such that the membrane may be connectable to the polymeric layers with laser transmission welding. For example, the flexible membrane may have absorbent properties at a predetermined wavelength, whereas the first and second polymer parts or the first and second polymeric component assembly may have transparent properties at the wavelength, such that the membrane may be fused with the polymer parts or polymeric component assemblies with laser transmission welding. Advantageously, the device can thereby be manufactured inexpensively.

In addition, a method of operating a variant of a microfluidic device that was previously presented is presented. The method comprises a step of introducing a sample material and, additionally or alternatively, a fluid into the fluidic channel system and a step of applying a pressure level to the pneumatic interface to control the microfluidic elements and process the sample material.

According to an exemplary embodiment, the method may comprise a step of aligning the microfluidic device with the earth's gravitational field. The alignment step may be carried out, for example, before the insertion step or between the insertion step and the pressure application step, in order to advantageously optimize guiding of fluid during the processing of sample material.

Exemplary embodiments of the approach presented here are shown in the drawings and explained in greater detail in the following description. The figures show:

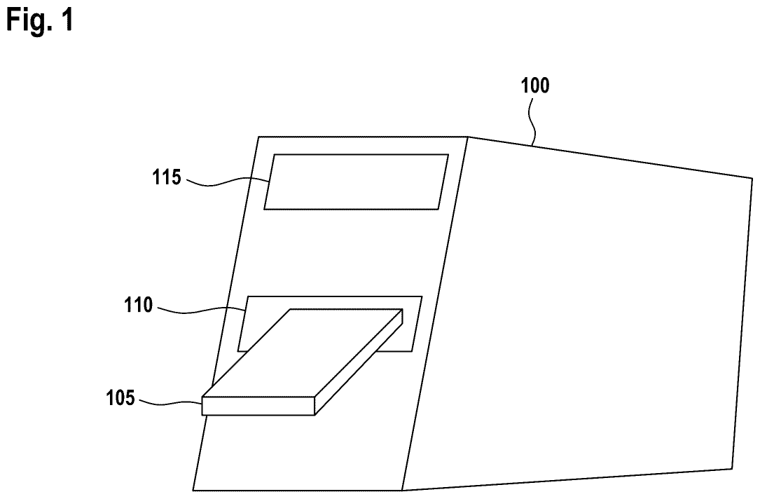

FIG. 1 a schematic representation of an exemplary embodiment of an analysis device;

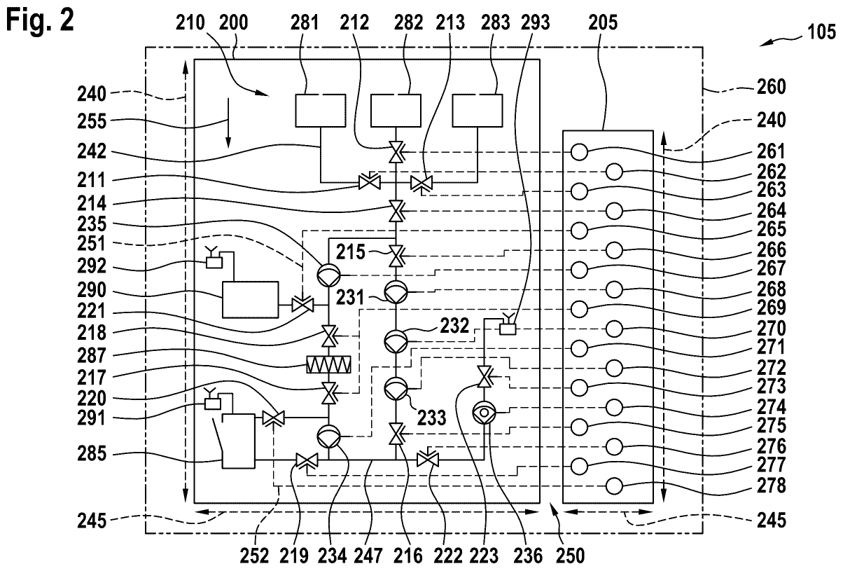

FIG. 2 a schematic representation of a microfluidic device according to an exemplary embodiment;

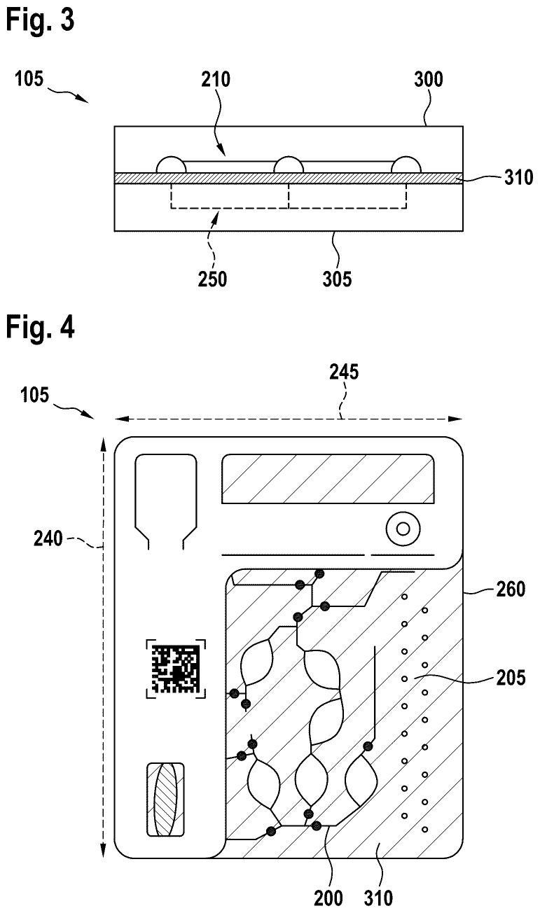

FIG. 3 a schematic cross-section of a device according to an exemplary embodiment;

FIG. 4 a schematic top view of a device according to an exemplary embodiment;

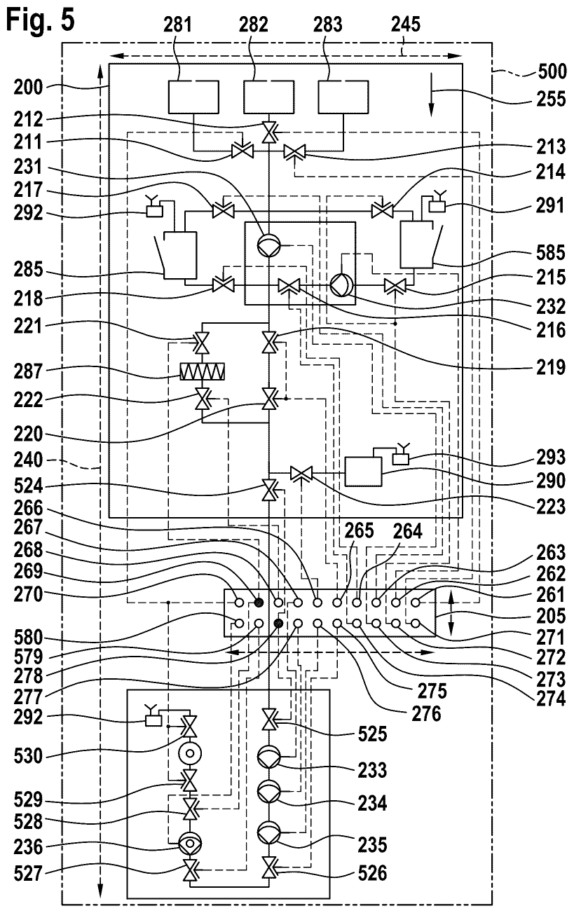

FIG. 5 a schematic representation of an exemplary embodiment of another microfluidic device with parallel guiding of the fluidic and pneumatic microchannels;

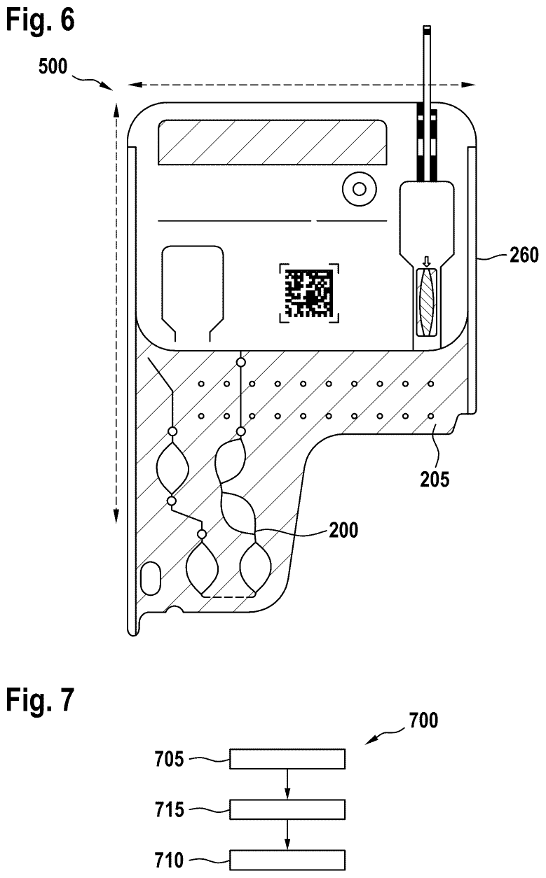

FIG. 6 a schematic top view of an exemplary embodiment of another microfluidic device; and

FIG. 7 a flow chart of a method for operating a microfluidic device according to an exemplary embodiment.

In the following description of advantageous exemplary embodiments of the present invention, identical or similar reference signs are used for elements shown in the various drawings which having a similar function, so a repeated description of these elements has been omitted.

FIG. 1 shows a schematic representation of an exemplary embodiment of an analysis device 100. In this exemplary embodiment, the analysis device 100 is designed to analyze samples that have been introduced, as a result of which it is, for example, possible to perform PCR tests. For this purpose, a microfluidic device 105, which is merely an example of a cartridge with a plastic housing and a microfluidic network for processing the sample, can be inserted into a receiving area 110. In this exemplary embodiment, the analysis device further comprises a display 115 with a touch function, by means of which settings for the desired analysis process can be entered manually. The display 115 is, by way of example only, also designed to display analysis results.

FIG. 2 shows a schematic representation of a microfluidic device 105 according to an exemplary embodiment. The microfluidic device 105 is configured to process a fluid as well as sample material dissolved in the fluid. Only by way of example, aqueous solutions and buffer solutions can be used. Furthermore, oils such as mineral, paraffin, or silicone oils and fluorinated hydrocarbons such as 3M Fluorinert FC-40, FC-70, or Novec 7500 may also be employed to produce multi-phase systems in device 105. The sample liquid can particularly be aqueous solutions with sample material contained therein, in particular with sample material of human origin derived from, for example, bodily fluids, swabs, secretions, sputum, or tissue samples. The targets to be detected in the sample liquid are particularly of medical, clinical, diagnostic or therapeutic relevance and comprise bacteria, viruses, certain cells, such as circulating tumor cells, cell-free DNA or other biomarkers.

To this end, the device 105 comprises a microfluidic network 200 depicted in the illustration here on the left side of the figure, and a pneumatic interface 205, shown in the figure here on the right, for connecting the device 105 to an analysis device as described in the previous figure. The analysis device is configured to apply at least two different pressure levels to the interface 205.

The microfluidic network 200 comprises a fluidic channel system 210 having a plurality of fluidic microchannels for transporting fluids. In the illustration shown here, the fluidic microchannels are outlined by solid black lines as examples. The fluidic channel system 210 comprises a plurality of microfluidic elements 211, 212, 213, 214, 215, 216, 217, 218, 219, 220, 221, 222, 223, 231, 232, 233, 234, 235, 236 connected by the fluidic microchannels, which are configured to cause controlled fluid displacement by means of pneumatic actuation. Only by way of example, these are microfluidic valves 211, 212, 213, 214, 215, 216, 217, 218, 219, 220, 221, 222, 223 and microfluidic pumping chambers 231, 232, 233, 234, 235, 236. In the illustration shown here, like microfluidic elements are depicted with like schematic reference numbers. Microfluidic valves 211, 212, 213, 214, 215, 216, 217, 218, 219, 220, 221, 222, 223 and pumping chambers 231, 232, 233, 234, 235, 236 are depicted with corresponding reference numbers. The fluidic microchannels of the fluidic channel system 210 have first fluidics sections 242 aligned along a first direction 240 and second fluidics sections 247 aligned along a second direction 245. For clarity, only one of the sections of the fluidic microchannels aligned in the first direction 240 and one of the sections of the fluidic microchannels aligned in the second direction 245 is given a reference number.

Furthermore, the network 200 of the device 105 comprises a pneumatic channel system 250 having a plurality of pneumatic microchannels for controlling the microfluidic elements 211, 212, 213, 214, 215, 216, 217, 218, 219, 220, 221, 222, 223, 231, 232, 233, 234, 235, 236. In the illustration shown here, the pneumatic microchannels are drawn as dashed lines as examples. The pneumatic channel system 250 is connected to the pneumatic interface 205, wherein the pneumatic microchannels aligned along the first direction 240 have first pneumatic sections 251 and the second pneumatic sections aligned along the second direction 245 have second pneumatic sections 252. For clarity, only one of the sections of the pneumatic microchannels aligned in the first direction 240 and one of the sections of the pneumatic microchannels aligned in the second direction 245 is given a reference number.

An entire length of the first fluidics sections 242 is greater than an entire length of the second fluidics sections 247 and an entire length of the first pneumatics sections 251 is smaller than an entire length of the second pneumatics sections 252. An entire length of an exemplary embodiment of the first fluidics sections 242 is significantly greater than an entire length of the second fluidics sections 247 and an entire length of the first pneumatics sections 251 is significantly smaller than an entire length of the second pneumatics sections 252. According to an exemplary embodiment, the entire length of the first fluidics sections 242 is greater by a factor of 2, 4, 8, or 16 than the entire length of the second fluidics sections 247. According to an exemplary embodiment, the entire length of the first pneumatics sections 251 is smaller than the entire length of the second pneumatics sections 252 by a factor of 2, 4, 8 or 16.

In this embodiment, the first direction 240 is oriented orthogonally with respect to the second direction 245, merely as an example. Accordingly, the device 105 is in particular characterized by the fluidic and pneumatic microchannels being perpendicular to each other or orthogonal. In this embodiment, a spatial extension of the microfluidic network 200 comprising fluidic channel system 210 and the pneumatic channel system 250 along the first direction 240 is greater than the spatial extension along the second direction 245. In addition, a spatial extension of the pneumatic interface 205 along the first direction 240 is greater than the spatial extension of the pneumatic interface 205 along the second direction 245. Stated differently, in the exemplary embodiment shown here, a vertical extension of the pneumatic interface 205 is greater than a horizontal extension of the pneumatic interface and a vertical extension of the fluidic network 200 is greater than a horizontal extension of the fluidic network 200. In this embodiment, the spatial extension of the total area of the pneumatic interface 205 corresponds to less than one third of the total area of the microfluidic network 200. As described above, the pneumatic interface 205 is arranged in an edge region between an edge of the device 105 and the substantially rectangular-shaped network 200 and extends along the first direction 240. In another embodiment, the pneumatic interface may form a maximum of one half of the total surface area of the device. In an exemplary embodiment, only as an example, in the operational state of the device 105 a force component of the gravitational field 255 of the earth additionally acts along the first direction 240. Starting from an earth gravitational field with a gravity acceleration of approximately 9.81 m/s², the device 105 is oriented at a predetermined angle or angular range to the field lines of the gravitational field, as an example. By way of example, the orientation of the device 105 along the vertical direction 240 relative to a plane that is oriented perpendicular to the field lines of the gravitational field corresponds to a 30° angle to utilize the gravitational field for the buoyancy-driven discharge of gas bubbles. In another exemplary embodiment, for example, the orientation may be at an angle of between 0 and 60°.

The pneumatic interface 205, in this embodiment, is arranged adjacent an edge 260 of the device 105, and by way of example only, has an arrangement of pneumatic connectors 261, 262, 263, 264, 265, 266, 267, 268, 269, 270, 271, 272, 273, 274, 275, 276, 277, 278 for connecting the pneumatic channel system 250 to the analysis device. The connections may also be referred to as ports. Only by way of example, the pneumatic connections 261, 262, 263, 264, 265, 266, 267, 268, 269, 270, 271, 272, 273, 274, 275, 276, 277, 278 are arranged in two rows along the first direction 240 in a hexagonal pattern. By way of example, the odd numbered connections 261, 263, 265, 267, 269, 271, 273, 275, and 277 in the illustration shown here are arranged in a first vertical row and the even numbered connections 262, 264, 266, 267, 268, 270, 272, 274, 276, and 278 are arranged in a second, parallel, vertical row. Within the rows, the ports are, by way of example, each the same distance from the adjacent ports. Only as an example, the two port rows are arranged one half port distance apart from one another with a hexagonal and equidistant arrangement of all pneumatic ports. The pneumatic channels emanating from the second row of ports are passed between the ports of the first row.

In an exemplary embodiment, the fluidic network 200 has an array of active microfluidic elements such as valves 211, 212, 213, 214, 215, 216, 217, 218, 219, 220, 221, 222, 223 and pumping chambers 231, 232, 233, 234, 235, 236 that are connected to one another via the fluidic channel system 210 and are further connected to other passive elements, i.e., elements that are not pneumatically controlled. The additional passive, i.e., non-pneumatically controlled elements, are, in an exemplary embodiment, liquid reagent pre-storage chambers 281, 282, 283, at least one (sealable) sample input chamber 285, a filter chamber 287 with integrated filter element, at least one liquid storage chamber 290, and vents 291, 292, 293 with fluid decoupling reservoirs. As shown in FIG. 2, the liquid reagent pre-storage chambers 281, 282, 283 are arranged in a second edge area between an edge of the device 105 and the microfluidic network 200, or in an edge area of the microfluidic network 200, along the second direction 245. In particular, the liquid reagent pre-storage chambers 281, 282, 283 are arranged above or at the upper edge of the microfluidic network 200 with respect to the acting gravitational force when the device 105 is used as intended. As can also be seen in FIG. 2, the pneumatic interface 205 and the liquid reagent pre-storage chambers 281, 282, 283 extend in orthogonal directions to each other, namely, along the first direction 240 and the second direction 245. Regardless of the specific configuration according to FIG. 2, the device 105 can also comprise a liquid reagent pre-storage chamber that extends over more than 50%, preferably more than 70%, quite preferably more than 90% of the width of the device 105 along the second direction 245, for example, as in the case of the example according to FIG. 2 along the second direction, also above the pneumatic interface 205. In other words, in preferred embodiments of the invention such as the exemplary embodiment shown in FIG. 2, both the pneumatic interface 205 and the liquid reagent pre-storage chambers 281, 282, 283 and the sample input chamber 285 are formed in peripheral areas of the microfluidic device 105 and the microfluidic network 200 for processing liquids is only located in the enclosed central area of the cartridge 105. In this way, a particularly advantageous reduction of the pump distances and channel volumes can be achieved. Thus, degradation of processing due to dead volumes can be reduced, and thus efficiency can be increased when transferring liquids in the microfluidic network.

Only as an example, the microfluidic device 105 is realized in the form of a polymer cartridge, and in particular a multilayer polymeric construction, such that it may be produced at low cost from polymer materials by the use of series production methods such as injection molding, punching and/or laser transmission welding.

The active microfluidic elements 211, 212, 213, 214, 215, 216, 217, 218, 219, 220, 221, 222, 223, 231, 232, 233, 234, 235, 236 are particularly suitable for pneumatically controlled production and control of microfluidic flow in the microfluidic network 200 of the microfluidic device 105. The active microfluidic elements in one exemplary embodiment are microfluidic valves 211, 212, 213, 214, 215, 216, 217, 218, 219, 220, 221, 222, 223 and pumping chambers 231, 232, 233, 234, 235, 236, which may cause liquids to be displaced from a dedicated part of liquid-conveying structures of the device 105, and which in particular are pneumatically controlled by a dedicated processing unit via an interface 205 with pneumatic ports 261, 262, 263, 264, 265, 266, 267, 268, 269, 270, 271, 272, 273, 274, 275, 276, 277, 278, such that fully automated microfluidic processing of the liquids in the polymeric cartridge is achievable.

For this purpose, the active microfluidic elements are realized in an exemplary embodiment using a flexible membrane adjacent two further rigid polymeric components, wherein at least one of the further polymeric components contains liquid-conveying structures.

A microfluidic valve 211, 212, 213, 214, 215, 216, 217, 218, 219, 220, 221, 222, 223 is, by way of example, realized by separating two liquid-conveying structures, particularly via a pneumatically caused deflection of a membrane, into a dedicated and, particularly, advantageously shaped partial volume of the liquid-conveying structures. Merely as an example, a displacement volume of a valve 211, 212, 213, 214, 215, 216, 217, 218, 219, 220, 221, 222, 223 when configured as a switching valve may be 80 nl to 1 μl, preferably 100 nl to 300 nl, and when configured as a pump valve 200 nl to 3 μl, preferably 500 nl to 2 μl.

A microfluidic pumping chamber 231, 232, 233, 234, 235, 236 is closely related to the valve and is also based on displacement of liquids from designated areas of liquid-conveying structures of the device 105. In contrast to valves, pumping chambers generally have a larger volume and are particularly used to temporarily hold defined liquid volumes, in particular to hold a significant portion or (nearly) the total volume of a liquid to be processed in a step of a microfluidic process. In an exemplary embodiment, the displacement volume of a pumping chamber 231, 232, 233, 234, 235, 236 is 10 μl to 50 μl, preferably 15 μl to 25 μl, for example 20 μl. A microfluidic pumping chamber is advantageously used in combination with two microfluidic valves enclosing the pumping chamber so as to realize a pumping unit, which allows as great a flow rate as possible in the microfluidic device 105 in as compact a space as possible. This is achieved in particular by the formation of the pumping unit from a pumping chamber 231, 232, 233, 234, 235, 236 with a large displacement volume, which can be used for pumping, i.e., for the directed displacement of liquids, and two valves 211, 212, 213, 214, 215, 216, 217, 218, 219, 220, 221, 222, 223 with a small displacement volume, which may be used for establishing and producing the pumping direction by means of a suitable actuation pattern, merely as an example. Overall, such a pumping unit is characterized by a large pumping volume per pumping step, as well as by a small space requirement for the realization of the pumping unit and a pulsatile, that is to say temporally changeable, flow rate profile. In the device 105 schematically illustrated in this figure, multiple such pumping units are realized by combining a pumping chamber with two adjacent microfluidic valves, for example the pumping chamber 235 with the adjacent valves 214 and 221 or the pumping chamber 234 with the adjacent valves 217 and 219.

In order to, in particular, induce pumping at a flow rate that is as constant and non-variable as possible, peristaltic pumping through peristaltic actuation of at least three homogeneous active microfluidic elements may work well, wherein the at least three active microfluidic elements may have a similar volume and, particularly, nearly the same volume. Peristaltic pumping with three similar, active microfluidic elements can be achieved independently of their (identical) displacement volume, i.e., in particular by the use of microfluidic valves, which can have a small displacement volume, or by the use of microfluidic pumping chambers, which can, in particular, have a larger displacement volume. In the device 105 schematically shown in this figure, such peristaltic pumping devices are realized by a combination of the three valves 212, 214, 215 and the three pumping chambers 231, 232, 233, as an example.

Consequently, with respect to peristaltic liquid transport, a conceptual distinction between “valve” and “pumping chamber” is unnecessary. The differentiation in terms is only useful if (like in the device 105) there is a multifunctional use of the microfluidic elements: A microfluidic element, which, in addition to producing peristaltic liquid transport, is primarily used in order to control the microfluidic flow within the microfluidic device, will therefore particularly be referred to as a microfluidic valve. A microfluidic element, which, in addition to producing peristaltic liquid transport, is used primarily to generate the microfluidic flow as well as for the interim storage of a significant part of the liquid volume to be processed within the microfluidic device, will therefore be referred to as a microfluidic pumping chamber.

Depending on the functionalities used of a microfluidic element, an advantageous configuration is as follows: A microfluidic valve, and in particular a microfluidic control or isolating valve, that is to say a microfluidic valve used exclusively for controlling the microfluidic flow or for separating liquid-conveying structures (and not for peristaltic liquid transport), therefore, has as little displacement volume as possible in particular, in order to, on the one hand, have as low a displacement volume as possible, which can be flushed in a microfluidic drain, if necessary, and on the other hand, to achieve the most compact possible implementation of the microfluidic device 105. By contrast, a pumping chamber, which is particularly used for the defined storage and measurement of liquids, has in particular a predetermined displacement volume, for example 20 μl, which substantially corresponds to the volume of liquid to be processed, or at least a significant fraction thereof. In the precise calculation of the displacement volume of a pumping chamber to process a predetermined liquid volume, the channel and valve volumes should also be included for precisely defined processing.

Regardless of the liquid conveying mechanism and the exact configuration of an active microfluidic element, liquid conveyance is achieved within the microfluidic device 105 as described above by deflecting a flexible polymeric membrane into liquid-conveying recesses of a rigid polymeric component, such that controlled displacement of liquids within the microfluidic device 105 can be achieved, particularly by applying different pressure levels to a pneumatic interface of the device. In addition to the active, that is pneumatically controlled, microfluidic elements for producing and controlling liquid transport in the fluidic network 200, in an exemplary embodiment, the device 105 comprises the passive elements described below:

The liquid reagent pre-storage chambers 281, 282, 283 are particularly for long-term stable pre-storage and defined releasability of liquid reagents needed to perform a test run in the device 105. The pre-storage chambers 281, 282, 283 contain, by way of example, all liquid reagents needed to perform a test run. In this way, with the exception of the sample, no input of further liquids into the device 105 is necessary to have a fully automated test run performed within the device 105.

The sample input chamber 285 is, in particular, configured to introduce a sample, for example a flocked swab with a swab sample or a sample liquid, that is a liquid with components of a sample, into the device 105. The sample input chamber 285 may be sealed with a lid element, by way of example only, in order to exclude contamination of the environment by the sample or vice versa of the sample by the environment. In a particular configuration, the sample input chamber 285 may be implemented with a length along the first direction 240, which is more than 50%, preferably more than 70%, quite preferably more than 90% of the length 240 of the device, which is particularly advantageous for receiving a long flocked swab.

The filter chamber 287 with integrated filter element is, in particular, configured to extract components from a sample fluid. Only as an example, the filter element may be a silica fabric suitable for extraction of deoxyribonucleic acids (DNA) or ribonucleic acids (RNA). The filter chamber 287 with filter element has a volume of 7 μl, by way of example only. In other exemplary embodiments, the filter chamber may have a volume of from 3 μl to 20 μl, preferably 5 μl to 10 μl. By arranging the filter chamber 287 with integrated filter element between the sample input chamber 285 and the liquid storage chamber 290, a particularly short pumping distance is advantageously possible when pumping sample liquid from the sample input chamber 285 into the liquid storage chamber 290 through the filter element (for extracting components from the sample liquid).

In an exemplary embodiment, the filter chamber 287 is separable via two microfluidic valves 217, 218 located on the microfluidic channel as close as possible to the filter chamber 287 on either side of the filter chamber 287 by closing the two switching valves from the channel and the fluidic channel system 210. The switching valves 217, 218 have a particularly low volume, by way of example only, to minimize the volume around the filter chamber 287. Furthermore, the switching valves 217, 218 are advantageously synchronized, that is, controlled collectively via exactly one pneumatic connection 269.

The liquid storage chamber 290 is configured in an exemplary embodiment to receive and store liquids, such as portions of a sample liquid, particularly after the extraction of components through the filter element. For example, the liquids remain in the liquid storage chamber 290 without contamination of the environment by a liquid even after a test run has already been performed in the lab-on-chip cartridge. This is particularly made possible with the implementation of a decoupling reservoir between the liquid storage chamber 290 and the vent 292.

The vents 291, 292, 293, in an exemplary embodiment, serve to vent the microfluidic system and, in particular, provide pressure compensation within the microfluidic system, for example during a pumping operation of a liquid from one of the liquid reagent pre-storage chambers 281, 282, 283, into the liquid storage chamber 290. In particular, in the microfluidic network 200 upstream of the vents 291, 292, 293, decoupling reservoirs are arranged, which prevent an undesirable leakage of liquid from the device 105.

The active and passive elements described are connected via microfluidic channels and thus form a microfluidic network 200, which comprises a suitable topology, i.e., spatial arrangement of the elements constituting the microfluidic network 200, in order to be able to perform at least one and in particular a plurality of microfluidic test procedures in the network.

To this end, in an exemplary embodiment, a microfluidic channel is formed around the filter chamber 287, which is adjacent to the filter chamber 287 on both sides and is, in particular, closed in a loop-like manner. In the exemplary embodiment shown schematically in this figure, the channel comprises elements 287, 218, 235, 215, 231, 232, 233, 216, 234 and 217. Here, the filter chamber 287 is framed by the switching valves 217 and 218 and is connected to the sample input chamber 285 and the liquid storage chamber 290 via T-shaped channel crossings, wherein the two T-shaped channel crossings surround the filter chamber 287 and the two switching valves 217, 218 arranged around the filter chamber, especially in such a way that there is as little volume as possible of the microfluidic channel, the filter chamber 287 and the switching valves 217, 218 between the two T-shaped channel crossings. Advantageously, this volume may be minimized in order to permit particularly efficient microfluidic processing, in particular in connection with the purification of a sample liquid.

Furthermore, in an exemplary embodiment, the fluidic network 200 includes a row-shaped arrangement of pumping chambers 231, 232, 233 and pump valves 215, 216, 217, 218 at the exemplary loop-shaped microfluidic channel, which can be used for conveying liquids through the filter chamber 287, particularly within the microfluidic channel, in particular an arrangement consisting of at least one pumping chamber and at least three pump valves, to achieve both pumping by means of the pumping chamber and peristaltic pumping by means of the at least three pump valves. The network 200 comprises at least three identical pumping chambers 231, 232, 233 in order to also enable peristaltic pumping with the identical pumping chambers 231, 232, 233. The exemplary loop-shaped closed channel with the filter chamber 287, the T-shaped channel crossings, the pumping chambers 231, 232, 233, 234, 235, and the microfluidic valves 215, 216, 217, 218 are separable from the remaining fluid network transport 200 in an exemplary embodiment by separator valves 214, 219, 220, 221, 222 to allow liquid transport in the loop-shaped closed channel. The three identical pumping chambers 231, 232, 233 are particularly arranged in series and are separable from the microfluidic channel by two valves 215, 216 and, in addition, are temperature-controlled after inserting the device 105 into an analysis device, individually, i.e., substantially independently of one another. In this way, in addition to purifying a sample substance, the device 105 may also be used for an amplification of sample material, in particular by means of a polymerase chain reaction.

In the advantageous exemplary embodiment shown schematically in this figure, the device 105 comprises four or more pumping chambers 231, 232, 233, 234, 235 (along a loop-shaped channel shown as an example only), to enable peristaltic pumping using the pumping chambers 231, 232, 233, 234, 235 or a transport of so-called liquid plugs within the device 105 having a volume substantially corresponding to the displacement volume of two or more pumping chambers 231, 232, 233, 234, 235. In this way, due to a simultaneous actuation of a plurality of the pumping chambers 231, 232, 233, 234, 235, larger liquid volumes may be handled as part of a pumping step, whereby the process time may be advantageously shortened, as an example.

FIG. 3a shows a schematic cross-section of a device according 105 to an exemplary embodiment. The device 105 shown here corresponds to or is similar to the device described in the preceding FIG. 2. In this exemplary embodiment, the device 105 comprises a first polymeric layer 300 and a second polymeric layer 305, which are connected to a flexible membrane 310, only as an example. Stated another way, the device 105 is realized in an exemplary embodiment in the form of a polymeric multilayer construction with a first polymeric component

or a first assembly of polymeric components and a second polymeric component or a second assembly of polymeric components, each of which are connected to a flexible

membrane 310, at least in partial areas. The polymeric layers 300, 305 are formed from polycarbonate (PC) by way of example only. In other exemplary embodiments, the components or assemblies may, additionally or alternatively, comprise further polymers, such as styrene-acrylonitrile copolymer (SAN), polypropylene (PP), polyethylene (PE), cycloolefin copolymer (COP, COC) or polymethyl methacrylate (PMMA), so that they can be manufactured by serial manufacturing methods such as injection molding or injection stamping. In one exemplary embodiment, a plurality of the fluidic microchannels of the fluidic channel system 210 are realized in the first polymeric layer 300 and a plurality of the pneumatic microchannels of the pneumatic channel system 250 are realized in the second polymeric layer 305. By deflecting the flexible membrane 310, the microfluidic flow through a channel is controllable or a microfluidic transport of liquids can be produced. For this purpose, the flexible membrane 310 is formed in an exemplary embodiment using thermoplastic elastomers (TPE) such as polyurethane (TPU) or styrenic block copolymer (TPS) and has microstructuring by means of punching. In an exemplary embodiment, the flexible membrane 310 has additional absorbent properties at a predetermined wavelength, whereas the first polymeric layer 300 and the second polymeric layer 305 have transparent properties at the wavelength, such that the membrane 310 may be fused with the polymer parts or polymeric component assemblies, particularly by means of laser transmission welding and, additionally or alternatively, with ultrasonic welding or adhesion.

FIG. 4 shows a schematic top view of a device 105 according to an exemplary embodiment. The device 105 shown here corresponds to or resembles the device described in the preceding FIGS. 2 and 3 and is realized with a fluidic network 200 and a pneumatic interface 205.

With the orthogonal system architecture of fluidic and pneumatic microchannels of the network 200, a particularly high integration density may be achieved and, thus, particularly compact dimensions of the device 105. The lateral dimensions of the device 105 are, only by way of example, 85 mm×68 mm, and thus smaller than the dimensions of, for example, 118 mm×78 mm of another device as described in the following FIGS. 5 and 6 with similar microfluidic functionality and parallel fluidic and pneumatic microchannels. In another exemplary embodiment, the device may have overall dimensions of 30×30 mm² to 300×300 mm², preferably 50×50 mm² to 150×100 mm².

The device 105 drawn in this figure is particularly based on a flexible, microstructured polymer membrane, which has been partially welded to two microstructured polymer components by laser welding, which can also be referred to as laser transmission welding.

Only as an example, liquid-conveying recesses are arranged in the rigid polymer components that comprise the microfluidic channels, pumping chambers and valves.

Furthermore, in one exemplary embodiment, at least one of the components has pneumatic microchannels, which may be used for controlling the active microfluidic elements, in particular the pumping chambers and the valves. Control of the microfluidic elements is accomplished by pressure-based, locally-defined deflection of the elastic membrane 310 into the recesses of the polymeric components forming the valves and pumping chambers. At least two pressure levels are used for controlling the microfluidic elements. In particular, control of the active microfluidic elements and provision of the pressure levels by an external analysis device is carried out as described in the previous FIG. 1. The device 105 can be controlled via the pneumatic interface 205 of the analysis device. In the exemplary embodiment shown here, the pneumatic interface 205 is arranged on the right edge 260 of the microfluidic device 105. The pneumatic channels, which may be used to control the microfluidic elements, are not discernible in the top view, because they are arranged in the lower polymeric component below the black, non-transparent membrane 310.

FIG. 5 shows a schematic representation of an exemplary embodiment of another microfluidic device 500 with parallel fluidic and pneumatic microchannels. As with the device shown in the previous FIG. 2, identical microfluidic elements are depicted with identical schematic reference numbers. A fluidic channel is drawn with a black line and a pneumatic channel with a dashed line. Microfluidic valves 211, 212, 213, 214, 215, 216, 217, 218, 219, 220, 221, 222, 223, 524, 525, 526, 527, 528, 529, 530 and pumping chambers 231, 232, 233, 234, 235, 236 are depicted with corresponding reference numbers and are controlled via a pneumatic interface 205 with pneumatic connections 261, 262, 263, 264, 265, 266, 267, 268, 269, 270, 271, 272, 273, 274, 275, 276, 277, 278, 579, 580. Furthermore, the device 500 comprises, in a similar manner to the device described in the preceding figures, via liquid reagent pre-storage chambers 281, 282, 283, sample input chambers 285, 585, a filter chamber 287 with filter element, a liquid storage chamber 290, and vents 291, 292, 293 with fluid decoupling reservoirs.

The parallel guiding of fluidic and pneumatic microchannels in the exemplary embodiment shown here correlates with the configuration of the pneumatic interface 205, with, in contrast to the device described in the preceding figures, a vertical extension, or an extension along the first direction 240 of the pneumatic interface 205 being smaller than a horizontal extension or extension along the second direction 245 of the pneumatic interface 205. In addition, in this embodiment, a vertical extension or extension along the first direction 240 of the fluidic network 200, is larger than a horizontal extension or extension along the second direction 245 of the fluidic network 200. In the operational state of the other device 500, a force component of a gravitational field 255 acts along the first direction 240, as before.

With respect to as compact a design and implementation as possible of the microfluidic device, the advantageous embodiment differs, as shown in the preceding figures, therefore, also particularly due to the spatial configuration of the pneumatic interface 205 relative to the fluidic network 200, wherein, in the advantageous embodiment, the direction of maximum extension of the fluidic network 200 matches the direction of maximum extension of the pneumatic interface 205.

According to prior art, the pneumatic interface 205 is implemented at a central position of the other microfluidic device 500 with respect to the analysis device, with the resulting pneumatic microchannels in the same direction as the fluidic microchannels. Such a configured, largely parallel design of fluidics and pneumatics is particularly obvious, since in this way, active microfluidic elements that are controllable via the parallel pneumatic channels may be arranged along the microfluidic channels.

Central positioning of the pneumatic interface 205 allows for control of active microfluidic elements arranged on either side of the pneumatic interface 205. However, due to the central positioning of the pneumatic interface 205, a passage of fluidic microchannels through the pneumatic interface 205 is required, which adversely affects the integration density of the pneumatic interface 205 and the resulting pneumatic channels in the other microfluidic device 500. Furthermore, with parallel fluidic and pneumatic microchannels, the number of microfluidic elements that may be achieved in this orientation is limited in a compact configuration of the microfluidic device with a vertical arrangement of the active microfluidic elements, in particular, by the dimensions of the pneumatic microchannels and the distances between them necessary for the other microfluidic device 500.

FIG. 6 shows a schematic top view of an exemplary embodiment of another microfluidic device 500. The other device 500 shown herein corresponds to or resembles the other device described in the preceding FIG. 5 and comprises a fluidic network 200 and a pneumatic interface 205, wherein the fluidic and pneumatic microchannels are substantially parallel to one another. Compared to the device shown in the preceding FIGS. 2, 3 and 4, the device 500 has larger spatial dimensions with similar scope of functions.

FIG. 7 shows a flowchart of a method 700 for operating a microfluidic device according to an exemplary embodiment. The method 700 comprises a step 705 of introducing a sample material and, as an example, a fluid into the fluidic channel system of the device and a step 710 of applying a pressure level to the pneumatic interface, in order to control the microfluidic elements and process the sample material. Merely by way of example, the method 700 illustrated here also includes a step 715 of aligning the microfluidic device in a gravitational field of the earth, wherein the alignment step 715 in this exemplary embodiment is performed between steps 705, 710 of insertion and applying pressure.

In other words, in the method 700 illustrated here, in the insertion step 705, a sample, such as a sample liquid or sampling device with attached sample material, is introduced into the microfluidic device. Subsequently, only by way of example, alignment of the microfluidic device to a gravitational field is performed in step 715, such that a non-vanishing force component of the gravitational field is present along the vertical direction. Only, by way of example, is the microfluidic device inclined towards the direction of action of a gravitational field, such as an angle of 30°. In this manner, with a suitable orientation of a chamber with a reaction bead and the adjacent microfluidic channels in the device, gas bubbles that may form upon dissolution of the bead may be discharged due to the buoyancy acting on the gas bubbles on account of the density difference compared to the surrounding liquid as driven by gravity, whereas the reaction mixture is free of gas bubbles after dissolution of the bead and may be further used.

Subsequently, only as an example, contact between the pneumatic interface of the microfluidic device and a processing unit or an analysis device is made. Optionally, further interfaces may also be produced, for example, at least one thermal interface for temperature-control of liquids in the device and/or at least one optical interface for detecting a fluorescence signal, which may emanate from a liquid in the device. By applying one or optionally several different pressure levels to the device via the pneumatic interface, a sample liquid in the device is processed by the analysis device and, optionally, an additional analysis result is output.

The stated dimensions and specifications are examples. For the design and functionality of the device, the properties of the liquids used, and the material and surface properties of the materials used, are additionally particularly important for implementation of the device.

1. A microfluidic device for processing a fluid, wherein the device comprises:
a pneumatic interface configured to connect the device to an analysis device, wherein the analysis device is configured to apply at least two different pressure levels to the interface;
a fluidic channel system comprising a plurality of fluidic microchannels configured to convey the fluid, wherein the fluidic channel system comprises a plurality of microfluidic elements, connected by the plurality of fluidic microchannels, which are configured to cause a controlled displacement of the fluid by pneumatic actuation, wherein each of the plurality of fluidic microchannels have respective first fluidics sections aligned along a first direction and respective second fluidics sections aligned along a second direction; and
a pneumatic channel system with a plurality of pneumatic microchannels configured to control the plurality of microfluidic elements, wherein the pneumatic channel system is connected to the pneumatic interface, wherein the pneumatic microchannels comprise first pneumatics sections aligned along the first direction and second pneumatics sections aligned along the second direction; wherein
an entire length of the first fluidics sections is greater than an entire length of the second fluidics sections and an entire length of the first pneumatics sections is smaller than an entire length of the second pneumatics sections.

2. The device according to claim 1, wherein the first direction is oriented orthogonally with respect to the second direction.

3. The device according to claim 1, wherein the entire length of the first fluidics sections is at least twice as large as the entire length of the second fluidics sections and/or wherein the entire length of the first pneumatics sections is at most half as large as the entire length of the second pneumatics sections.

4. The device according to claim 1, wherein a spatial extension of a microfluidic network comprising the fluidic channel system and the pneumatic channel system along the first direction is greater than a spatial extension along the second direction and wherein a spatial extension of the pneumatic interface along the first direction is greater than a spatial extension of the pneumatic interface along the second direction.

5. The device according to claim 1, wherein in an operational state of the device a force component of the gravitational field of the earth acts along the first direction.

6. The device according to claim 1, wherein the pneumatic interface comprises an arrangement of pneumatic connections configured to connect the pneumatic channel system to the analysis device.

7. The device according to claim 6, wherein the connections of the pneumatic interface are arranged in at least two rows along the first direction, and wherein the connections are arranged hexagonally and/or equidistant to one another.

8. The device according to claim 1, wherein the pneumatic interface makes up a maximum of one half of a total surface area of the device, and wherein the interface is arranged adjacent to an edge of the device.

9. The device according to claim 1 having at least one liquid reagent pre-storage chamber configured for long-term stable storage of liquids within the microfluidic device.

10. The device according to claim 9, wherein the at least one liquid reagent pre-storage chamber extends along the second direction, and wherein the pneumatic interface extends along the first direction.

11. The device according to claim 1, wherein the device comprises a first polymeric layer and a second polymeric layer joined to a flexible membrane at least in partial areas, wherein in the first polymeric layer there are more fluidic microchannels of the plurality of fluidic microchannels than in the second polymeric layer and in the second polymeric layer there are more pneumatic microchannels of the plurality of pneumatic microchannels than in the first polymer layer.

12. The device according to claim 11, wherein the flexible membrane has absorbent properties at a predetermined wavelength and the first polymeric layer and/or the second polymeric layer have transparent properties at the predetermined wavelength such that a membrane is connectable to the polymeric layers by laser transmission welding.

13. A method for operating the microfluidic device according to claim 1, comprising:
introducing a sample material and/or a fluid into the fluidic channel system; and
applying a pressure level to the pneumatic interface to control the microfluidic elements to process the sample material.

14. The method according to claim 13, further compromising:
aligning the microfluidic device in a gravitational field of the earth.
